(19) United States
(12) Patent Application Publication
(10) Pub. No.: US 2003/0069380 A1
(43) Pub. Date: Apr. 10, 2003

(54) POLYURETHANE AQUEOUS DISPERSIONS AND PREPARATION METHOD

(76) Inventors: JEAN-JACQUES FLAT, SERQUIGNY (FR); JEAN-LAURENT PRADEL, BERNAY (FR); JACQUES FONTELA, BERNAY (FR)

Correspondence Address: Frederick F. Calvetti, Smith, Gambrell & Russell, Beveridge, De Grandi, Weilacher & Young - Intellectual Property Group, 1850 M Street, N. W. Suite 800, Washington, DC, 20036, US

(21) Appl. No.: 09/445,644

(22) PCT Filed: Mar. 19, 1999
(86) PCT No.: PCT/FR99/00638

(30) Foreign Application Priority Data
Mar. 25, 1998 (FR) 98.03793

(51) Int. Cl. C08G 18/00

(52) U.S. Cl. 528/44

(57) ABSTRACT

The invention relates to a process for preparing aqueous polyurethane dispersions, which comprises the following steps:

(a) formation of a prepolymer having NCO functional groups by reaction, in a solvent, of a polyisocyanate, a polydiene having hydroxyl terminal groups and a mass \overline{M}ₙ of at least 2000 and a diol containing neutralized acid functional groups, the NCO functional groups being in excess with respect to the OH functional groups;

b) dispersion of the prepolymer in water;

(c) addition of a diamine-type chain extender;

(d) evaporation of the solvent in order to obtain an aqueous polyurethane-urea dispersion.

It also relates to aqueous dispersions essentially containing no solvent and containing 30 to 40% by weight solids; the coatings that are obtained from these dispersions are particularly hydrophobic.

The invention relates to aqueous polyurethane dispersions and a process for preparing them.

For environmental reasons, the coatings and adhesives industry is from now on making use of systems in aqueous phase. The polyurethanes normally used in this field require the insertion of ionic groups into their chain so that it is possible for them to be dispersed in water.

U.S. Pat. No. 5,672,653 describes aqueous polyurethane dispersions prepared from a polyol comprising at least one polydiene having hydroxyl terminal groups.

The preparation of a prepolymer starts by reacting a polyol, a diisocyanate and a diol containing acid groups

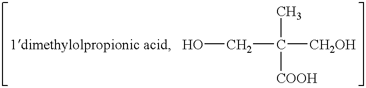

which has been dissolved beforehand in N-methyl-pyrrolidone (NMP). The reaction takes place in the presence of a catalyst (dibutyltin dilaurate). The ratio NCO/OH of the number of NCO functional groups to the number of OH functional groups is from 2 to 2.5.

The polyol used is a mixture of a hydrophobic hydroxytelechelic polybutadiene of high molecular weight (\overline{M}ₙ=2800) (for example, polyBd® R45HT from the Applicant) and a less hydrophobic polyol such as PolyBd® R20LM or polyether polyols or polyester polyols in PolyBd R45HT/other polyol molar ratios of between 60/40 and 30/70.

Next, the acid functional groups are neutralized by triethylamine and water is then added in order to disperse the prepolymer. Finally, adding a chain extender (ethylenediamine or hydrazine hydrate) makes it possible to obtain an aqueous polyurethane-urea dispersion. A film can be then be produced by evaporation.

The products described in the above patent have two characteristics:

\mathring{1} presence of residual NMP in the emulsion (because its boiling point is too high to be easily distilled);

\mathring{2} the presence of polyols less hydrophobic than PolyBd R45HT in the polyurethane emulsion gives the films produced from the PUD a lower hydrolysis resistance than hoped for.

Depending on the applications of these dispersions, the presence of residual solvent and the sensitivity to hydrolysis may be drawbacks.

A process has now been found which allows these two problems to be solved.

It consists firstly in neutralizing the acid functional groups of dimethylolpropionic acid and then in dissolving it in methyl ethyl ketone. Next, the prepolymer is prepared as described above. The invention also relates to aqueous dispersions essentially no longer containing solvent and giving, after the water has been evaporated, coatings that are particularly resistant to hydrolysis.

The present invention relates to a process for preparing aqueous polyurethane dispersions, which comprises the following steps:

(a) formation of a prepolymer (having NCO functional groups) by reaction, in a solvent, of a polyisocyanate, a polydiene having hydroxyl terminal groups and a mass \overline{M}ₙ of at least 2000 and a diol containing neutralized acid functional groups, the NCO functional groups being in excess with respect to the OH functional groups;

(b) dispersion of the prepolymer in water;

(c) addition of a diamine-type chain extender;

(d) evaporation of the solvent in order to obtain an aqueous polyurethane-urea dispersion.

The coatings obtained from these dispersions are particularly hydrophobic.

By way of illustration of polyol-polydienes (polydienes having hydroxyl terminal groups) that can be used according to the present invention, mention may be made of oligomers of a hydroxytelechelic conjugated diene, it being possible for these to be obtained by various processes such as the radical polymerization of a conjugated diene having from 4 to 20 carbon atoms in the presence of a polymerization initiator such as hydrogen peroxide or an azo compound such as 2,2′-azobis [2-methyl-N-(2-hydroxy ethyl)-propionamide] or the anionic polymerization of a conjugated diene having from 4 to 20 carbon atoms in the presence of a catalyst such as dilithium naphthalene.

According to the present invention, the conjugated diene of the polyol-polydiene is chosen from the group comprising butadiene, isoprene, chloroprene, 1,3-pentadiene and cyclopentadiene. The number-average molar mass of the polyols that can be used may vary from 2000 to 15,000 and preferably from 2000 to 5000.

According to the present invention, a butadiene-based polyol-polydiene will preferably be used. Advantageously, the polydiene glycol comprises 70 to 85 mol %, preferably 80 mol %, of units

—(—CH₂—CH═CH—CH₂—)—

And 15 to 30 mol %, preferably 20 mol %, of units

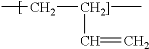

Also suitable are copolymers of conjugated dienes and of vinyl and acrylic monomers, such as styrene and acrylonitrile.

It would not be outside the scope of the invention if hydroxytelechelic butadiene oligomers epoxidized on the chain or else partially or completely hydrogenated hydroxytelechelic oligomers of conjugated dienes were to be used.

The OH number (I_{OH}) expressed in meq/g is between 0.5 and 1.5 and preferably 0.8 to 0.9. Their viscosity is between 1000 and 10,000 mPa.s.

By way of illustration of polyol-polydienes, mention will be made of polybutadiene having hydroxylated terminal groups, which is sold by ELF ATOCHEM S.A. under the name PolyBd® R45HT.

The prepolymer may also contain a short diol in its composition. As examples of such a diol, mention may be made of, N,N-bis(2-hydroxypropyl)aniline and 2-ethyl-1,3-hexanediol. The amount of such a diol is advantageously between 1 and 30 parts by weight per 100 parts of polydiene having hydroxyl terminal groups.

According to the present invention, the polyisocyanate used may be an aromatic, aliphatic or cycloaliphatic polyisocyanate having at least two isocyanate functional groups in its molecule.

By way of illustration of aromatic polyisocyanates, mention may be made of 4,4′-diphenylmethane diisocyanate (MDI), liquid modified MDIs, polymeric MDIs, 2,4- and 2,6-tolylene diisocyanate (TDI) as well as mixtures thereof, xylylene diisocyanate (XDI), triphenylmethane triisocyanate, tetramethylxylylene diisocyanate (TMXDI), paraphenylene diisocyantate (PPDI) and naphthalene diisocyanate (NDI).

Among the aromatic polyisocyanates, the invention preferably relates to 4,4′-diphenylmethane diisocyanate and most particularly to liquid modified MDIs.

By way of illustration of aliphatic polyisocyanates, mention will be made of hexamethylene diisocyanate (HDI) and its derivates, and trimethylhexamethylene diisocyanate.

By way of illustration of cycloaliphatic polyisocyanates, mention will be made of isophorone diisocyanate (IPDI) and its derivates, 4,4′-dicyclohexylmethane diisocyanate and cyclohexyl diisocyanate (CHDI).

The invention preferably relates to IPDI.

The diol containing neutralized acid functional groups may, for example, be dimethylolpropionic acid neutralized by triethylamine.

It is possible to add a catalyst which may be chosen from the group comprising tertiary amines, imidazoles and organometallic compounds.

By way of illustration of tertiary amines, mention may be made of 1,4-diazabicyclo[2.2.2]octane (DABCO).

By way of illustration of organometallic compounds, mention may be made of dibutyltin dilaurate and dibutyltin diacetate.

The amounts of catalyst may be between 0.01 and 5 parts by weight per 100 parts by weight of polyol (polydiene having hydroxyl terminal groups and diol having an acid functional group).

The amount of isocyanate is advantageously such that the NCO/OH molar ratio is greater than 1.4 and preferably between 1.5 and 2.5. The OH functional groups are those of the polydiene and of the diol having an acid functional group.

The amount of diol containing neutralized acid functional groups is advantageously such that there may be from 0.2 to 2.5 carboxylate functional groups per chain of polydiene having hydroxyl terminal groups. The solvent is such that it allows the prepolymer to be synthesized and to be removed easily at step (d). Preferably, methyl ethyl ketone (MEK) is used. This step (a) is carried out in conventional stirred reactors.

The amount of water at step (b) is such that at step (d) a dispersion containing 30 to 40% by weight of solid matter is obtained. At step (b), water is advantageously introduced into a stirred reactor. This step (b) may be carried out at any pressure, and more simply at atmospheric pressure. The temperature may be between room temperature and 80° C. and preferably is room temperature.

As a chain extender in step (c), mention may be made of hydrazine in aqueous solution or ethylenediamine. The reaction may be carried out between room temperature and 80° C. and preferably at room temperature and at atmospheric pressure. The chain extension may be followed by volumetric determination of the isocyanate functional groups in the dispersion over time. The reaction time is about 10 minutes.

Step (d) may, for example, be a distillation, carried out in any standard device.

The aqueous dispersions obtained essentially no longer contain solvent and have a low viscosity, for example from 4 to 10 centipoise (or millipascal.second or mPa.s) and contain from 30 to 40% by weight of solids.

The coatings obtained exhibit very good moisture resistance and have a very low glass transition temperature, possibly as low as −60 to −70° C. for example.

The coatings are therefore flexible at low temperature.

The present invention also relates to the aqueous dispersions themselves. They essentially no longer contain solvent, and advantageously contain less than 0.2% by weight. Their viscosity is advantageously less than 15 mPa.s and preferably about 4 to 5 mPa.s. They contain 30 to 40% by weight of solids. The particle size is less than 100 nm and advantageously between 50 and 80 nm.

The coatings obtained by evaporating these dispersions have a water uptake of less than 2%, and advantageously about 1%, when exposed at 20° C. for 24 hours.

The water uptake is less than 3% and is about 1.7% when exposed at 100° C. for 2 hours.

### EXAMPLES

1. Products

PolyBd R45HT: hydrophobic hydroxytelechelic polybutadiene having a \overline{M}ₙ of 2800 g/mol, a hydroxyl number of 0.83 meq/g and a viscosity of 5000 mPa.s at 30° C., sold by Elf Atochem.

PolyBd R20LM: hydroxytelechelic polybutadiene having an \overline{M}ₙ of 1370 g/mol, a hydroxyl number of 1.70 meq/g and a viscosity of 1600 mPa.s at 30° C., sold by Elf Atochem.

DMPA: dimethylolpropionic acid having a molecular mass of 134 g/mol, sold by Angus.

IPDI: isophorone diisocyanate having an NCO content of 37.8%, produced by Hüls.

DBTL: dibutyltin dilaurate sold by Air Products.

TEA: triethylamine sold by BASF.

Hydrazine hydrate: aqueous hydrazine solution containing 63.5% hydrazine in water, sold by Elf Atochem. 2. Composition

| | A | B |
|---|---|---|
| PolyBd R45HT | 243 | 243 |
| PolyBd R20LM | | 147 |
| DMPA | 11.1 | 37.9 |
| DBTL | 0.4 | 0.49 |
| MEK | 490 | |
| NMP | | 66.8 |
| TEA | 8.37 | 28.7 |
| Hydrazine hydrate | 5.7 | 27.7 |
| IPDI | 64.2 | 227.2 |
| Water | 763 | 2171 |

A is according to the invention. B is according to U.S. Pat. No. 5,672,653.

3. Processes

Test A (According to the Invention)

Mixed in an Erlenmeyer flask are the DMPA, the TEA, the DBTL and 200 g of MEK. The entire contents are homogenized until all the ingredients have dissolved in the solvent. During this time, the PolyBd R45HT is degassed for one hour at 80° C. under vacuum in a jacketed reactor.

The DMPA/TEA/DBTL/MEK mixture is added to the PolyBd cooled to 40° C., as is the rest of the MEK. The mixture is taken to MEK reflux. The reaction is left to continue for 4 hours and the prepolymer obtained is discharged.

Placed in a reactor are 247 g of deionized water to which 265 g of the above prepolymer are added, drop by drop over 90 minutes. At the end of this time, 1.93 g of hydrazine hydrate is poured in and the stirring (turbine stirrer with blades inclined at 45° C., 500 rpm) is left for a further 5 minutes.

The MEK is then distilled off from the aqueous dispersion under reduced pressure using a rotary evaporator and then filtered on a 100 μm filter cloth.

Test B (Not According to the Invention)

The DMPA is dissolved in the NMP at 60° C. in a reactor. This solution is then introduced into a jacketed reactor preheated to 60° C. and put under nitrogen. Next, the PolyBd R45HT, the PolyBd R20LM and the DBTL are incorporated. After homogenization, the IPDI is introduced. The reaction takes place over 4 hours at 60° C.

The TEA is then introduced into the reactor and the reaction mixture is stirred for 30 minutes.

Water is then added by pouring it in over 10 minutes and the reaction mixture is stirred using a turbine mixer having 45°- inclined blades at 1000 rpm. The hydrazine hydrate is then introduced drop by drop, with stirring. The stirring is left for a further 30 minutes. 4. Characterization

4.1. Stability of the Isocyanate Prepolymers

The isocyanate prepolymers according to A and B were characterized as a function of time. Their viscosity at 25° C. was measured using an RVT DV3 Brookfield viscometer; d₀ corresponds to the day of their synthesis.

| | A | B |
|---|---|---|
| d₀ | 30 cP | 1700 cP |
| d₀ + 7 days | 85 cP | gelled |
| d₀ + 14 days | 735 cP | gelled |

These results show that the prepolymer according to A has a lower initial viscosity and a better storage capability.

4.2 Characteristics of the PUDs

The average particle sizes of the PUD were measured using an apparatus of the MALVERN brand.

The viscosity of the PUDs was measured at 25° C. using a small-specimen adapter with an RVT DV3-type Brookfield viscometer. The pH of the emulsions was measured using a METROHM pH-meter.

The minimum film-forming temperature (MFT) was measured using an apparatus of the GÖTT.FERT brand.

The content of volatile organic compounds (VOC) was measured by chromatography.

The elongation at break and the tensile strength of the materials were measured according to the DIN 53504 standard, and the Shore hardness according to DIN 53505.

The water uptake of the materials corresponds to the increase in mass observed following a treatment in water, under the recommended conditions.

| | A | B |
|---|---|---|
| Particle size | 70 nm | 110 nm |
| Viscosity (25° C.) | 7.2 cP | 6.1 cP |
| pH | 7.2 | 7.2 |
| MFT | no MFT | no MFT |
| Volatile organic compound (%) | <0.2 (MEK) | 2.5 (NMP) |
| Tensile strength (MPa) | 6.3 | 12.2 |
| Elongation at break (%) | 500 | 260 |
| Shore hardness | 67 A | 46 D |
| Water uptake: | | |
| 24 h at 20° C. | 1% | 45% |
| 2 h at 100° C. | 1.7% | 90% |

This table demonstrates that the emulsions according to the invention contain very small VOC contents and exhibit excellent hydrolysis resistance.

1. Process for preparing aqueous polyurethane dispersions, which comprises the following steps:
(a) formation of a prepolymer having NCO functional groups by reaction, in a solvent, of a polyisocyanate, a polydiene having hydroxyl terminal groups and a mass \overline{M}ₙ of at least 2000 and a diol containing neutralized acid functional groups, the NCO functional groups being in excess with respect to the OH functional groups;
(b) dispersion of the prepolymer in water;
(c) addition of a diamine-type chain extender;
(d) evaporation of the solvent in order to obtain an aqueous polyurethane-urea dispersion.

2. Process according to claim 1, in which the polydiene having hydroxyl terminal groups is a polybutadine having hydroxyl terminal groups.

3. Process according to either one of the preceding claims, in which the diol having acid functional groups is dimethylolpropionic acid.

4. Process according to either one of the preceding claims, in which the solvent is methyl ethyl ketone.

5. Process according to any one of the preceding claims, in which the isocyanate is isophorone diisocyanate (IPDI).

6. Aqueous polyurethane dispersions based on a prepolymer (i) having an isocyanate functional group comprising a polyisocyanate, a polydiene having hydroxyl terminal groups and a mass \overline{M}ₙ of less than 2000 and a diol containing neutralized acid functional groups, which has reacted with (ii) a diamine-type chain extender, these dispersions essentially containing no solvent, having a viscosity of less than 15 mPa.s and containing 30 to 40% by weight of solids.
